(19) United States
(12) Patent Application Publication
(10) Pub. No.: US 2015/0159628 A1
(43) Pub. Date: Jun. 11, 2015

(54) OFFSHORE CONTRA ROTOR WIND TURBINE SYSTEM

(71) Applicant: KARI APPA, Irvine, CA (US)

(72) Inventor: KARI APPA, Irvine, CA (US)

(21) Appl. No.: 14/100,025

(22) Filed: Dec. 9, 2013

(51) Int. Cl. F03D 9/00; F01K 15/00; F03B 13/00

(52) U.S. Cl. CPC F03D 9/002; F03B 13/00; F01K 15/00

(57) ABSTRACT

The present invention provides a system for an energy efficient contra rotor wind turbines. The system comprises two dual aerodynamic rotors composed of plurality of helically contoured blades. The blades on the outer rotor are set to spin in the first direction about the outer shaft, while the blades on the inner rotor are set to spin in a second direction about the co-axially mounted inner shaft. The inner shaft drives the magnetic field of a generator; the outer rotor drives the wound armature of the generator. Additionally the optimal blade setting can be done by means of the tip speed selection and requiring no blade pitching and no yawing requirement and also control the rotors speeds whenever their rotational speeds exceed the design limits Energy extraction can be enhanced by means of coaxially ducted flow concept in horizontal axis wind turbines.

### BACKGROUND

1. Technical Field

The embodiments herein generally relate to the field of generating electric power using wind or any kinetic fluid media energy sources. More specifically, the embodiments described herein relate to the development of energy efficient offshore wind turbine system, having plurality of counter rotating turbine rotors mounted on coaxial shafts, set to spin in opposite direction to each other.

2. Description of the Related Art

According to the prior art, there are two types of wind turbines, which spin about a horizontal axis (HAWT), and the other type spin about a vertical axis (VAWT).

Conventional HAWT models uses radially extended blades spinning about a horizontal axis. The available wind power is related to the square of the blade length or the swept area. These blades are designed to be very massive at the root section to provide required structural strength against the high centrifugal force of the spinning blade, as well as bending and twisting moments. Furthermore, the blade weight and cost also increase as the cube of the blade length. Consequently, the conventional HAWT unit, having radially extended blades, encounters some design constraints on practical design of pitch and yaw controllers. Further, it has been realized that the levelized cost of energy (LCOE) increases with higher power rated turbines. Hence, alternate energy efficient and low cost design methodologies, such as vertical axis turbines (VAWT) as well as horizontal axis turbines (HAWT), are sought in this innovation.

The current VAWT models, according to publications, U.S. Pat. No. 5,020,967, U.S. Pat. No. 6,309,172 B1, and US 2010/0003130, spin at low rotational speeds and generate far less power compared to the horizontal axis wind turbines. The main reason being that the prior arts employ the drag component of the aerodynamic force, instead of the lift component which is much more efficient, to propel the turbine rotors. In addition, all vertical turbines produce undesirable turbulence and vibrations leading to detrimental efficiency loss and poor reliability.

Hence there is a need for an energy efficient wind turbine, which provides optimal performance at both low and high wind speed conditions. Further, it is desirable to have safe and noise free wind turbines for residential use, both in urban and rural communities.

### OBJECTS OF THE INVENTION

An object is to provide an electrical energy producing wind turbine apparatus for offshore installation at low cost.

Another object is to provide safe and noise free electric power generating wind turbines at all wind speeds.

The other objects and advantages of the present invention will be apparent from the following description when read in conjunction with the accompanying drawings which are incorporated for illustration of preferred embodiments of the present invention and are not intended to limit the scope thereof.

### SUMMARY

In view of the foregoing, an embodiment herein provides an energy efficient and light weight turbine design methodology, having helically contoured blades, which may be mounted on a horizontal axis or on a vertical axis, supporting system, depending on the need basis. This turbine can be operable in any kinetic fluid media, such as; wind, water, gas and steam. The new design addresses above stated limitations and disadvantages, and the resulting improvements.

In accordance with an embodiment, the above-mentioned objectives are achieved by providing special design features of turbines, such as the HAWT and the VAWT models. Said apparatus comprise of dual rotors mounted on coaxial shafts set to spin in opposite direction to each other, hereinafter referred to as the contra rotor (CR) turbine, designated as CR-HAWT for the axis-symmetric flow models and the CR-VAWT for the cross flow models, respectively.

According to an embodiment, the CR unit comprises a pair of coaxially mounted aerodynamic rotors set to spin in opposite directions to each other, wherein, the magnetic field of its electrical generator is driven by an inner rotor having helical blades, while the armature unit of the generator is driven by an outer rotor comprising plurality of helically contoured blades.

According to an embodiment, the contra rotor vertical axis wind turbine system either of the CR-VAWT or CR-HAWT model, comprises a pair of aerodynamic torque producing cylindrical rotors that includes an inner rotor and an outward rotor, wherein each rotor having plurality of blades, wherein the outward rotor is firmly supported to an outer shaft and its blades are set to spin the rotor in a first direction, wherein the inner rotor is firmly fixed to a coaxially mounted inner shaft and its blades are set to spin the rotor in a second direction, opposite to the first direction, wherein the inner shaft is coupled to the magnetic field element of an electrical generator and the outer shaft is coupled to a wound armature of the generator.

According to an embodiment, the above-mentioned objectives are further achieved by judicious choice of the rotor tip speed ratio which ensures best aerodynamic load distribution without requiring the blade pitch adjustment.

According to an embodiment, the above mentioned objectives are further achieved by providing the features of controlling the rotor speeds by natural means, thereby ensuring the safe operation and reliability of the equipment at all wind conditions.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a sectional view of an exemplary embodiment of a typical offshore contra rotor vertical axis wind turbine comprising of two vertical rotors set to spin in opposite direction to each other and coupled to drive the magnetic field and an armature of a generator supported on an air cushioned platform, according to an embodiment herein;

FIG. 2 illustrates a plan view of a light weight helically contoured blade of the exemplary embodiment, mounted on a rotor at varies azimuth angular positions, according to an embodiment herein;

FIG. 3 illustrates a hinge based assembly of a helical blade, according to an embodiment herein;

FIGS. 4a and 4b illustrate top and bottom circular rings that support blades using hinges, according to an embodiment herein;

FIG. 5 illustrates a velocity vector components and the resultant velocity vector on an airfoil, together with together with the corresponding lift and drag components, according to an embodiment herein;

FIG. 6 illustrates a magnitude of the velocity and force vectors on an airfoil moving against the wind and another airfoil moving with the flow, according to an embodiment herein;

FIG. 7 illustrates a plan view of two airfoil sections mounted on an inner rotor and an outer rotor, together with their resultant velocity vectors, as they move in opposite directions, according to an embodiment herein;

FIG. 8 illustrates a cross sectional view of plurality of airfoils on an inner rotor and an outer rotor set to spin in opposite direction to each other, according to an embodiment herein;

FIG. 9 illustrates a starting torque of a typical blade, according to an embodiment herein;

FIG. 10 illustrates a starting torque of a typical rotor, according to an embodiment herein;

FIG. 11 illustrates a torque and power distribution of a blade, according to an embodiment herein;

FIG. 12 illustrates a torque and power distribution of a rotor, according to an embodiment herein;

FIG. 13 illustrates a performance characteristics of single rotor of a VAWT unit, such as; torque, power, rotor speed and power coefficient at various wind speeds, according to an embodiment herein;

FIG. 14a and FIG. 14b illustrate an arrangement of an offshore floating platform of a multi megawatt utility scale wind turbine, according to an embodiment herein;

FIG. 15 illustrates a section view of land based version of the contra rotor VAWT, according to an embodiment herein;

FIG. 16 illustrates section view of an assembly of coaxial shafts and an alternator, according to an embodiment herein;

FIG. 17 illustrates a cross sectional view of the CR-HAWT model along with two rotors and an alternator assembly, according to an embodiment herein;

FIG. 18a illustrates a method of improving the annual energy yield, using plurality of contra rotor turbine units in an open stream of wind, such as in the case of offshore installations, according to an embodiment herein;

FIG. 18b illustrates an alternate method of improving the annual energy yield, wherein, one set of contra rotor turbine unit is disposed in a coaxially ducted flow stream, according to an embodiment herein;

FIG. 19a, FIG. 19b and FIG. 19c illustrate the helically contoured blade configuration in axis symmetric flow, such as in the case of CR-HAWT, according to an embodiment herein;

FIG. 20a illustrates a method of fabricating a non-symmetric airfoil section of a helically contoured blade with constant angle of incidence, in an axis symmetric flow, according to an embodiment herein;

FIG. 20b illustrates a helically contoured blade configuration having some part of its leading edge set normal to the onset wind streamline, so as to generate starting torque in the axis symmetric flow field, according to an embodiment herein;

FIG. 20c illustrates an alternate method of generating starting torque, wherein a strip of an airfoil is mounted on the supporting arm, having its leading edge set normal to the onset wind streamline in the axis symmetric flow field, according to an embodiment herein;

FIG. 21 illustrates a typical rotor assembly using helically contoured blades, according to an embodiment herein;

FIG. 22 illustrates a typical power performance characteristic of the outer rotor of an offshore HAWT unit, in symmetric flow, according to an embodiment herein; and

FIG. 23 illustrates a typical power performance characteristic of the outer rotor of an offshore HAWT unit, in a coaxially ducted symmetric flow, according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The detailed description is first presented with respect to the CR-VAWT model, and followed by that for the CR-HAWT model outlining only the major differences.

### Contra Rotor—VAWT in Cross Flow Field:

According to an embodiment, a vertical axis wind turbine system is provided, wherein the system comprises a pair of aerodynamic torque producing cylindrical rotors such as an inner rotor and an outward rotor, wherein each rotor having plurality of blades. The outward rotor is firmly supported to an outer shaft and its blades are set to spin the rotor in a first direction. Whereas the inner rotor is firmly fixed to a coaxially mounted inner shaft and its blades are set to spin the rotor in a second direction, opposite to the first direction. Further the outer shaft is coupled to a wound armature unit of an electrical generator and the inner shaft is coupled to a magnetic field unit of said generator.

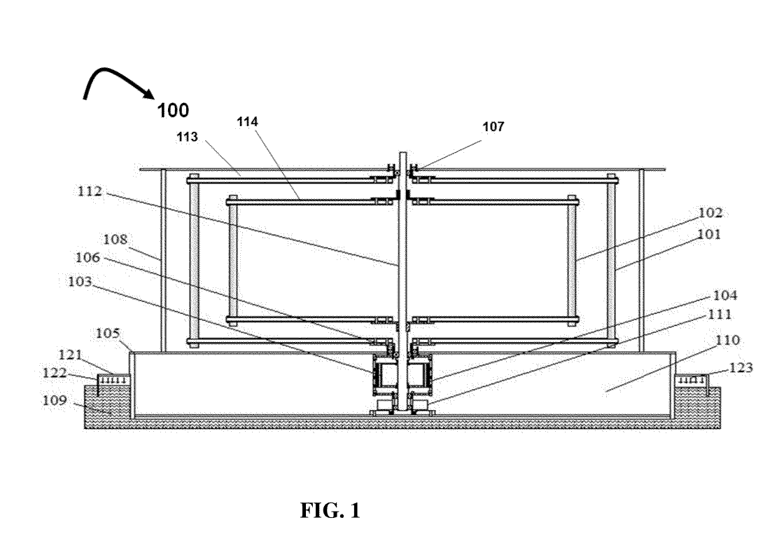

FIG. 1 illustrates a sectional view of a vertical axis wind turbine 100 having dual rotors set to spin in opposite direction to each other (herein onwards referred to as CR-VAWT) in accordance with an embodiment. The CR-VAWT 100 comprises an outer rotor 101 engaged to drive an electrical generator by means of an outer shaft 107. The aerodynamic rotor 101 in turn comprises an assembly of plurality of helically contoured blades mounted on plurality of supporting upper and lower arms 113, which are in turn mounted on a rotating coaxially mounted shaft 107. The outer shaft is firmly fixed to the wound armature 104 of an alternator.

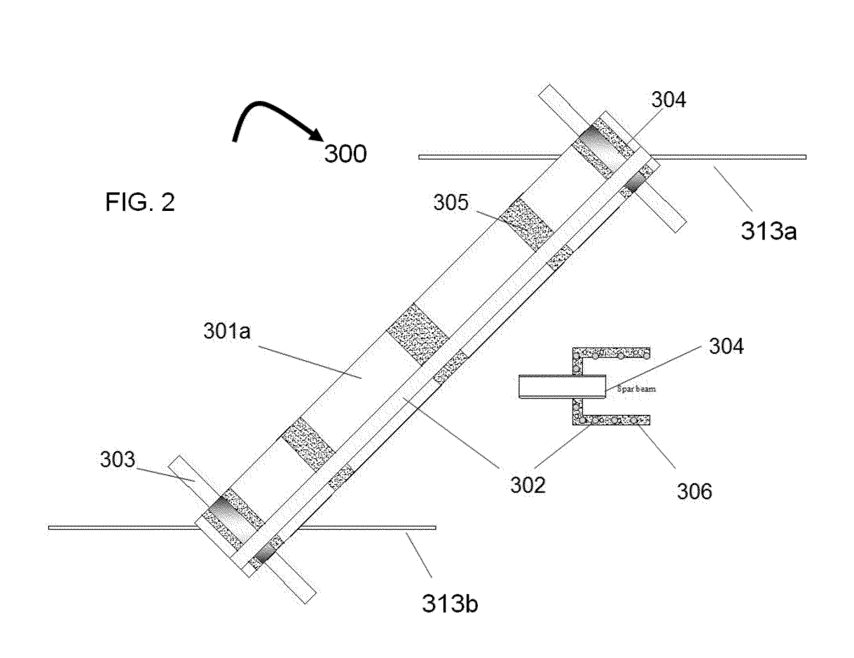

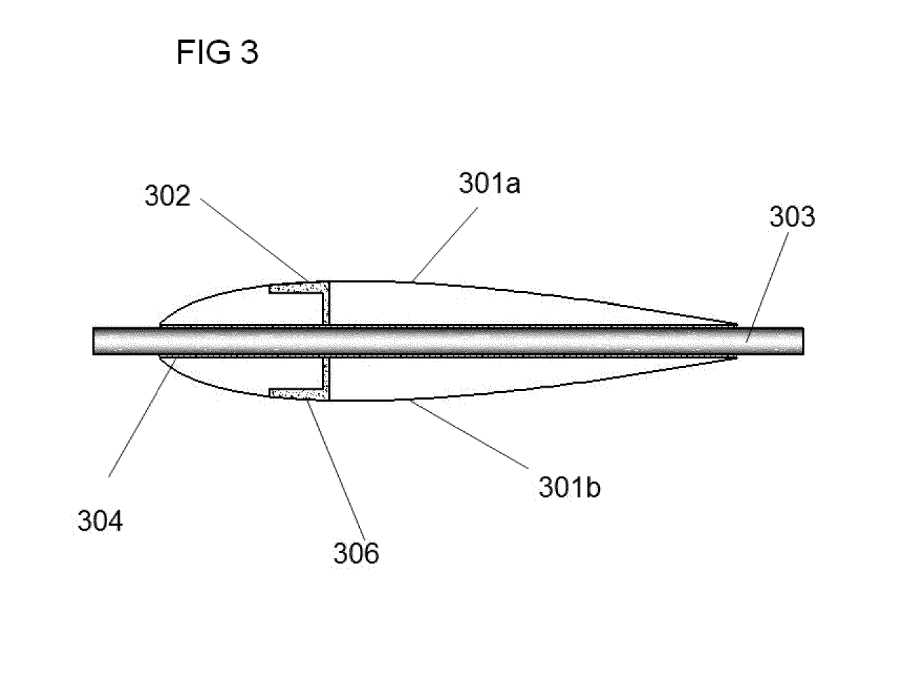

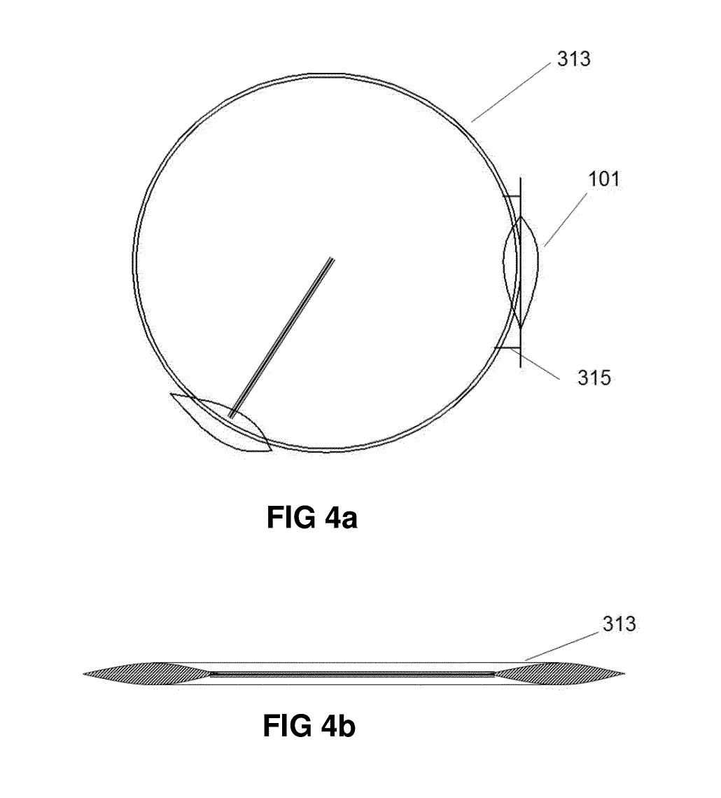

Plurality of helically contoured blades, may alternately be supported on a pair of upper and lower circular arc shaped airfoil rings 313, (FIG. 2, FIG. 4a, FIG. 4b), by means of hinged assemblies, comprising of a sleeve 304 and a bolt 303 (FIG. 3). The hinged support devise is introduced to reduce the bending strains in the blade and thus minimize the blade weight and also enhance durability. The blade setting angle 315 is denoted in FIG. 4a.

FIG. 2 illustrates the components of a light weight blade assembly 300 in accordance with an embodiment. The blade assembly 300 comprises an outer airfoil shell 301a, an inner airfoil shell 301b (FIG. 3), plurality of wires 306, reinforced into the composite spar beam 302, together with plurality of aerofoil shaped composite supporting elements 305, a pair of hinge assembly, 303, 304, supported on a pair of upper and lower circular rings 313a, 313b, having circular arc shaped cross section, also of composite nature. FIGS. 4a and 4b illustrate the top and bottom supporting rings. These supporting rings are employed to support plurality of blades with drastically reduced drag forces.

An exemplary outline of the hinge assembly is illustrated in FIG. 3. The load carrying reinforced composite spar element 302, comprises a hinge assembly 303, 304 together with couple of strands of reinforcing rope wires 306, which carry the tensile force generated by the blade sections between the hinges. Thus, the fabrication of light weight blades becomes possible.

Likewise, the inner aerodynamic rotor 102 in turn comprises an assembly of plurality of similar helically contoured light weight composite blades, mounted on plurality of supporting upper and lower arms 114, which are in turn mounted on a rotating coaxial shaft 112 which in turn is coupled to the magnetic field unit 103 of the alternator. Due to helical configuration of the blades mounted on inner and outer rotors, gradually varying torque is generated at all azimuth locations of the rotor, without giving rise to pulsating forces. Hence no blade pitching device is required for the blades mounted on inner and outer rotors. The assembled CR-VAWT 100 may then be mounted on a stationary supporting frame work 105 and 108. To transfer the electrical power generated by the rotating armature, a slip ring assembly 111 is implemented. Both rotors are supported on a bearing assembly 106, comprising of a set of unidirectional and load carrying bearings.

In the case of an offshore installation, an air cushioned floating platform, comprising of a deck 121, an elastic skirt 122, and a pressurized air chamber 123 of required air pressure to balance the total weight of the VAWT unit. The total system may be floating on the water body 109. Depending on the total system weight, necessary degree of air space pressure may be created to balance the weight. This air chamber 110 acts as a damper as well during tidal wave motion.

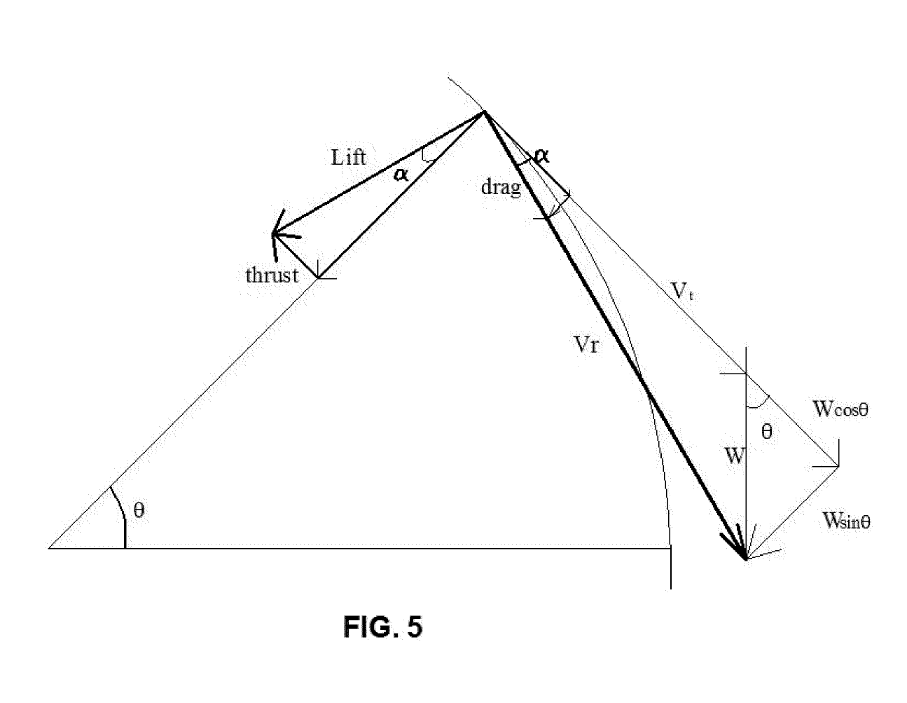

In an embodiment, FIG. 5 illustrates the construction of the velocity vector diagram to determine the angle of incidence (a), between the resultant velocity vector V_{R} and the chord line of the blade. There are three velocity vectors namely:
the tangent velocity vector V_{T}=ω*R, which is the result of the angular velocity, omega ω(radians per second) of the blade directed opposite to the blade motion, and is perpendicular to the radial line,
the wind speed velocity Wₛ, which is parallel to the wind direction;
Vector addition of these two components results in the resultant velocity vector, V_{R}.

The included angle between V_{R} and V_{T} is termed as the aerodynamic angle alpha (α) and is given by,

α=arc tan(sin [symbol] /(λ+cos [symbol] ))<α(C_{Lmax}),

in which [symbol] , is the azimuth angle, and λ is the tip speed ratio.

This angle changes as the blade moves along the azimuth angle theta. For better aerodynamic performance, the angle of incidence, alpha (α) must be less than the angle required for C_{L}/C_{D}, max. This requirement can be achieved by judiciously selecting the tip speed ratio, TSR=λ. The corresponding lift and drag components are shown in FIG. 5.

### Rotor Speed Control:

FIG. 5 illustrates the velocity vector diagram of a VAWT rotor. The W is the wind speed, and V_{T}, is the rotor tangent velocity, where the rotor changes speed, while the wind speed W is constant. As the rotor speed increases, for some reason at the same wind speed, the tip speed ratio increases, resulting in reduced angle of incidence, consequently, generating less load. From this we understand, for any wind speed within the desired range, the rotor is self-controlled. This means, if the rotor is slower than that required by the TSR, angle of incidence increases, and vice versa.

However, there is a need to control the rotor speed, if the wind speed exceeds the permissible range. This can be achieved by increasing the alternator torque, by varying the flux density of the magnetic field unit. The PM based magnetic field unit may have a few auxiliary windings around the PM. By varying the d. c. current flow, based on the required rotor rpm, the field strength can be varied to provide matching torque, within designed wind speed range, so that the rotor never attains a run-away speed with increasing wind speed.

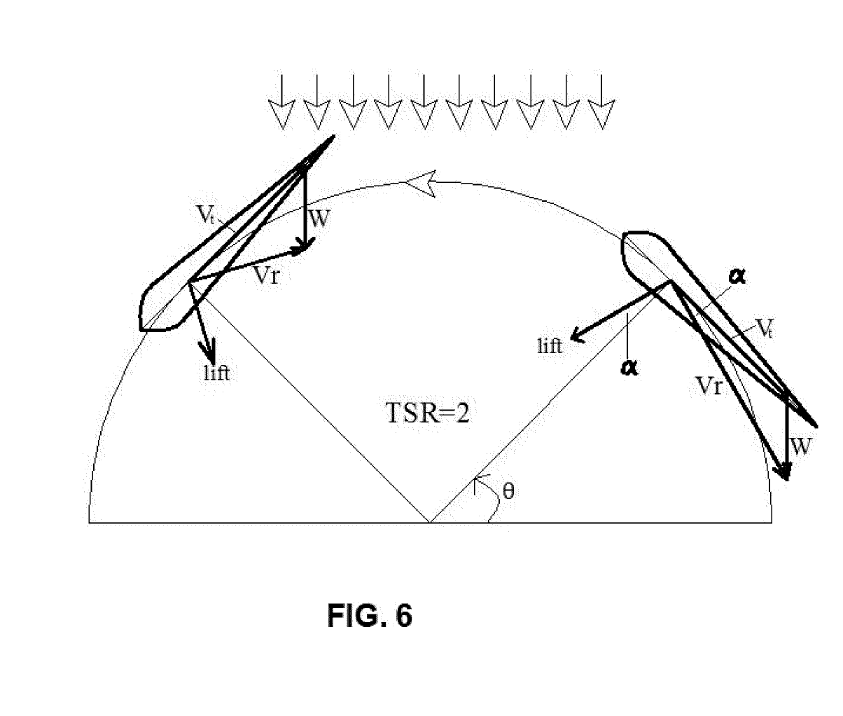

FIG. 6 illustrates the magnitudes of the resultant velocity vectors as the blades move against the flow, having larger resultant velocity vector V_{R}, and smaller or zero velocity vector as the blade moves in the same direction as the flow, according to an embodiment. Since, energy extraction depends of the magnitude of the velocity vector, less energy may be extracted when the blade moves with the flow. For this reason, the vertical axis wind turbines (VAWT) are seen to be less efficient than the corresponding, horizontal axis wind turbines (HAWT).

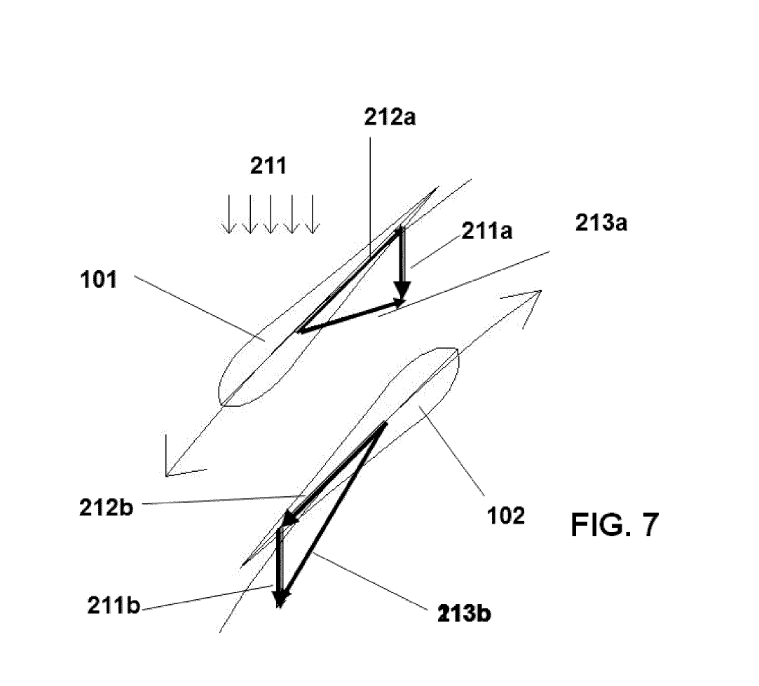

This deficiency can be corrected by introducing an inner rotor 102 as depicted in FIG. 7, and comprising of plurality of helically contoured blades set to spin in opposite direction to the outer rotor 101. The airfoil sections of both rotor blades are assumed to be symmetric for simplicity, or specially designed for optimal performance. The on set flow is denoted by 211, while 211a and 211b denote the cross flow velocity components at the outer and inner rotor blades respectively. The tangential velocity components for the outer rotor and the inner rotor are denoted by 212a and 212b, respectively.

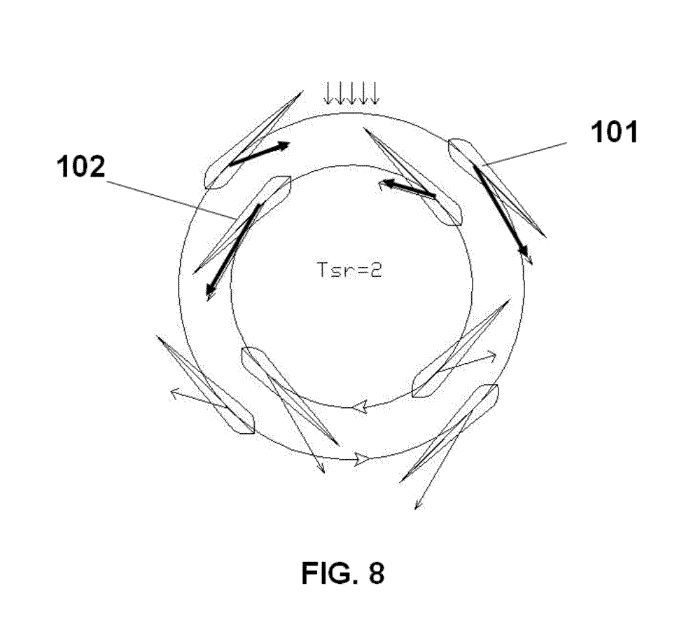

FIG. 8 shows the plan view of air foils on outer and inner rotors set to rotate in opposite direction to each other, according to an embodiment. The magnitudes of the resultant velocity vectors are seen to complement each other. In other words, if the resultant velocity vector on one side of rotor blade decreases, that on the other side of the rotor increases resulting in enhanced energy production, as much as 50 percent more than that of a single rotor system.

In addition, the contra rotor motion of the rotors results in increased flux speed, leading to higher power for the same sized electrical generator. Since, the contra rotor turbines are generally direct drive units; they may have lower cut-in wind speed and also yield higher annual energy due to its ability to start at low wind speeds and extract more energy from the wind.

### Aerodynamic Forces and Power Analysis in Cross Flow

Let the angle of incidence between the airfoil chord and the resultant velocity vector, V_{R} be, α. Then the lift and drag coefficients transformed with respect to the relative velocity vector, V_{R}, are given by:

C_{N}=C_{L}*cos(α)+C_{D}*sin(α): normal component of lift and drag coefficients directed radially inward

C_{T}=C_{L}*sin(α)−C_{D}*cos(α): tangential component of lift and drag coefficients directed in the direction of blade motion
wherein, the wind tunnel measured, C_{L} and C_{D} are generally referred to the airfoil chord.
The angle of incidence, α, referring to FIG. 5, is given by;

α=arc tan(sin( [symbol] )/(λ+cos( [symbol] )),
where [symbol] is the azimuth angle, of the blade position and 1 is the TSR. For a given airfoil section, the optimal angle of incidence corresponding to (C_{L}/C_{D}) max, can be achieved by selecting an appropriate TSR, λ.
Thus, the resulting load on the blade is given by:

dL=[0.5*ρ*V_{R}²*chord*BL], for each blade,
where BL=blade length, and chord=blade width.
The forces normal and parallel to the tangent velocity vector V_{T} are given by;

FN=dL*C_{N} directed radially inward or outward

FT=dL*CT directed tangentially
The resulting torque is given by:

T=Nb*R*FT Newton·meter,
where Nb is the number of blades, and R is the radius of the rotor.
The corresponding power is given by

P=T*ω Watts
The Coefficient of Power, CP=P/(0.5*ρ*R*H*Ŵ3), where W is the free stream velocity and H is the rotor height.

FIG. 7 and FIG. 8 denote the resolved resultant velocity vectors on the inner and outer rotors which spin in opposite direction to each other, according to an embodiment. This suggests that both rotors complement each other in recovering the energy left over by one rotor. Thus, it may be possible that the coefficient of power C_{P}, of the VAWT, which was considered to be small in comparison to the HAWT models, may compare to be in par or may exceed.

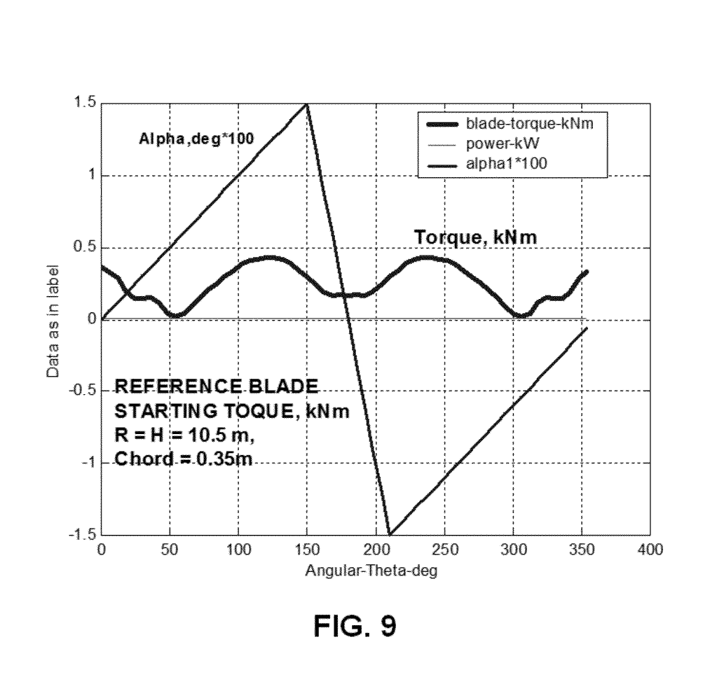

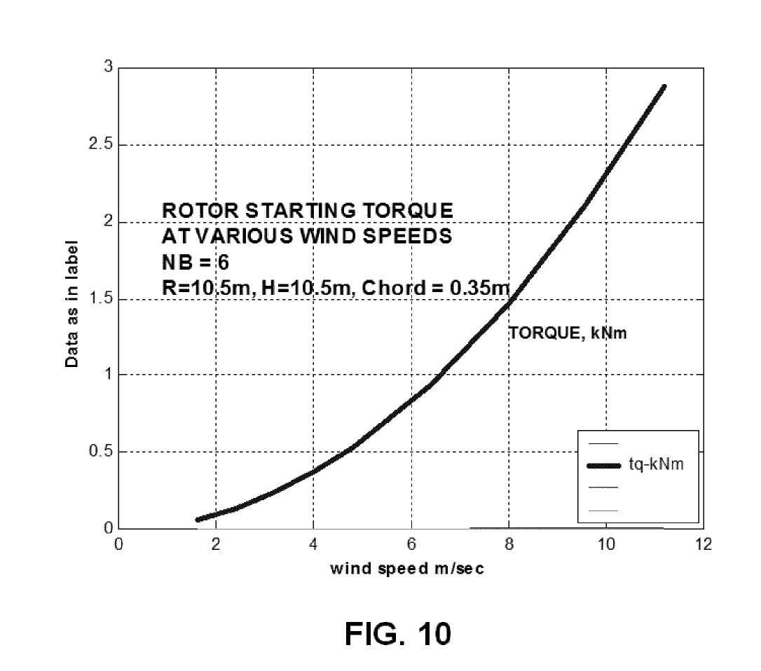

According to an embodiment, FIG. 9 depicts the starting torque developed by each blade as the function of the azimuth angle, θ, while FIG. 10 denotes a uniform starting torque for a rotor having plurality of helically contoured blades. Each blade show positive torque, at all blade positions.

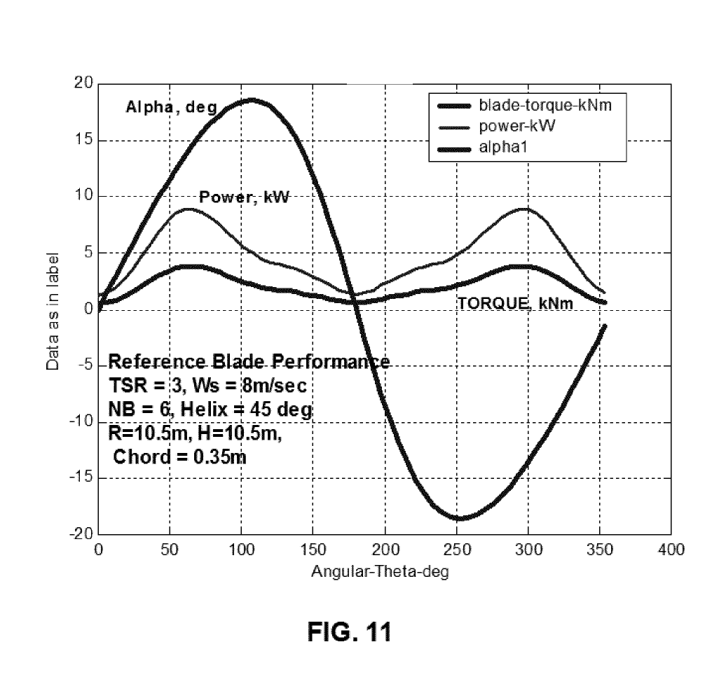

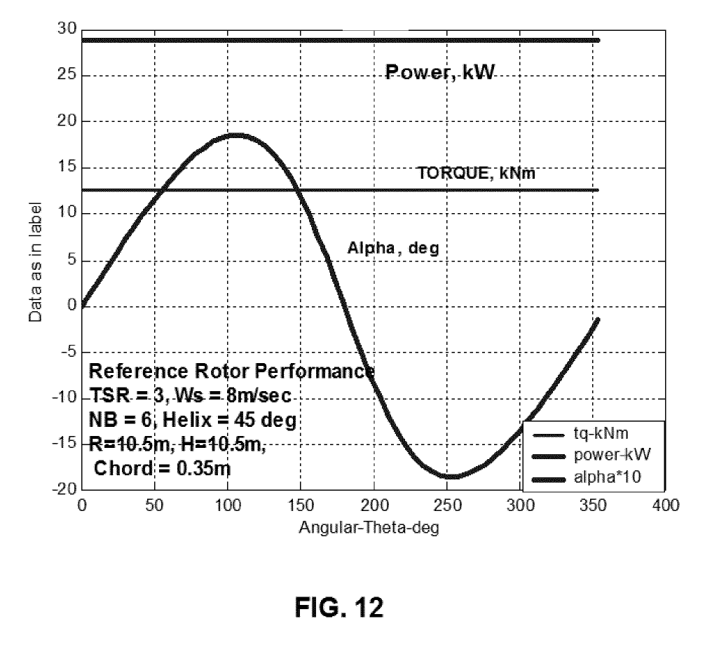

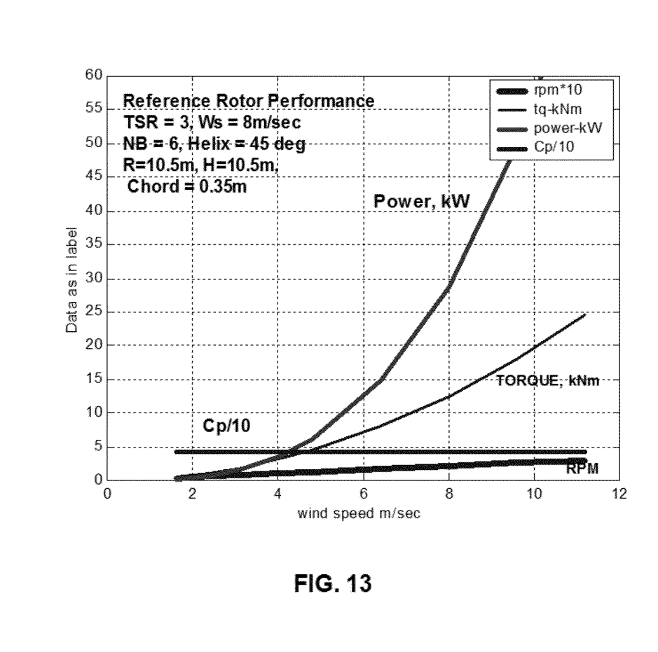

FIGS. 11 and 12 show the torque and power distribution of a typical offshore multi MW outer rotor unit, according to an embodiment. The torque and power distribution for a rotor is seen to be continuous and non-pulsating unlike in the case of the Darrius turbine. FIG. 13 shows torque, power, rotor speed and the power coefficient Cp distributions at various wind speeds.

The selection of the blade chord C and the number of blades Nb plays a decisive role for optimal performance of a VAWT. For example:

Nb*C=f(λ,R,C_{L},C_{M}),

where, λ is the tip speed ratio, R is the rotor radius, C_{L} lift coefficient and C_{M} is the mechanical efficiency of the turbine. Because of asymmetry of flow (FIG. 6), the C_{Pnet} is seen to be ˜0.3 for practical VAWT units. But, the theoretical value for any vertical turbine is seen to be 16/25. This suggests that the contra rotor technology, in the case of VAWT may yield Cp=˜16/25 or better. To achieve optimum performance of the CR-VAWT, the angle of incidence a shall not exceed that corresponding to the C_{L} max. This is possible, by selecting proper TSR, rotor radius for a specific wind speed range.

### Contra Rotor—HAWT in Axis Symmetric Flow:

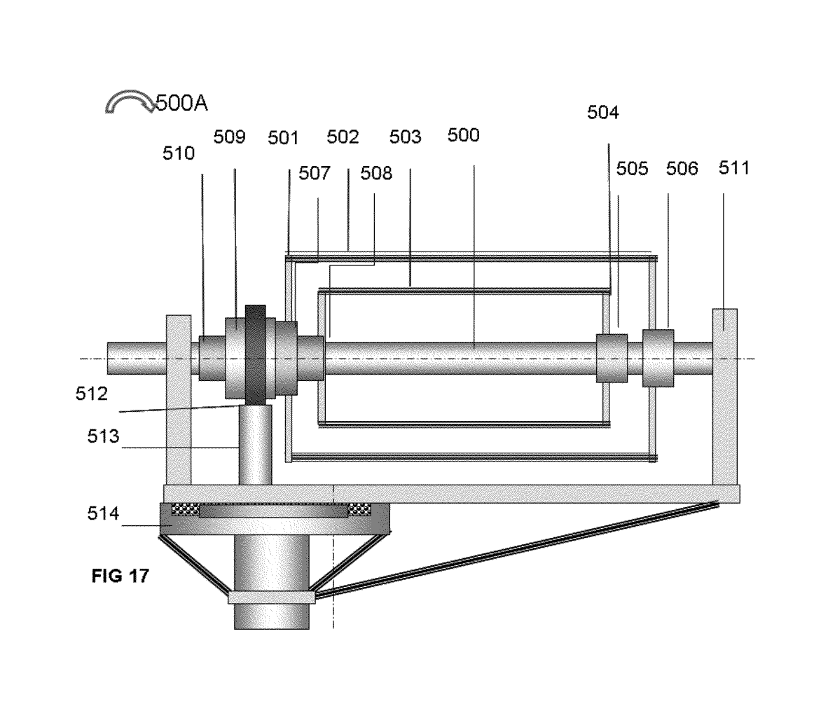

According to another embodiment, a horizontal axis turbine system is provided, as depicted in FIG. 17, wherein it comprises of a pair of aerodynamic torque producing cylindrical rotors such as an inner rotor and an outward rotor, wherein each rotor having plurality of helically contoured blades. The outward rotor is firmly supported on to an outer shaft and its blades are set to spin the rotor in a first direction. Whereas the inner rotor is firmly fixed to a coaxially mounted inner shaft and its blades are set to spin the rotor in a second direction, opposite to the first direction. Further the outer shaft is coupled to a wound armature unit of an electrical generator and said inner shaft is coupled to a magnetic field unit of said generator. Furthermore, unlike in the case of the VAWT in cross flow field, the airfoils in the HAWT unit have constant angle of incidence at all azimuth locations. Hence, non-symmetric airfoils are used to achieve better performance. The total CR turbine system assembly is rotatably mounted on a stationary shaft 500 as depicted in FIG. 17.

### Contra Rotor—HAWT in Open Air:

FIG. 17 illustrates a sectional view of a horizontal axis wind turbine 500A, disposed in open air, having dual rotors set to spin in opposite direction to each other (referred to as the CR-HAWT unit). In accordance with one embodiment, the CR-HAWT 500A comprises of an outer rotor assembly 501, 502 engaged to drive an electrical generator by means of an outer shaft 507. Said outer aerodynamic rotor, in turn comprises of an assembly of plurality of helically contoured blades 502, such as the one shown in FIG. 2, mounted on plurality of supporting first end and second end supporting arms 501, which are in turn mounted on a rotating coaxially mounted shaft 507. The outer shaft is firmly fixed to the wound armature 104 of an alternator.

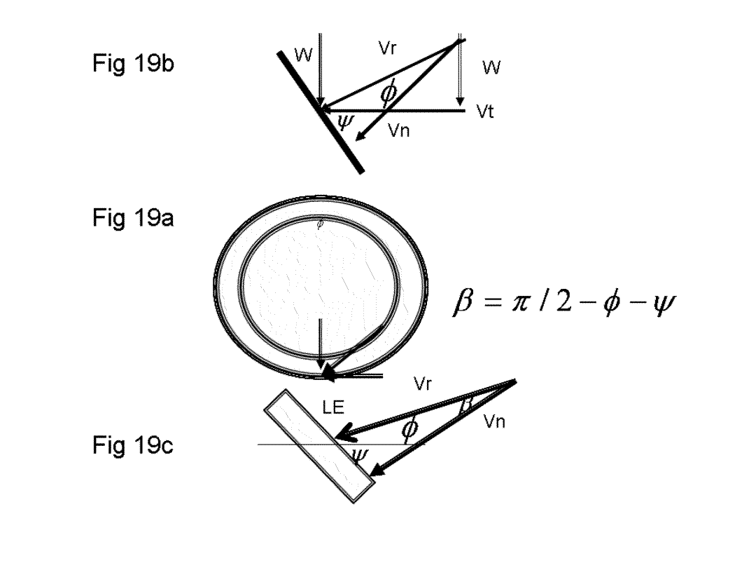

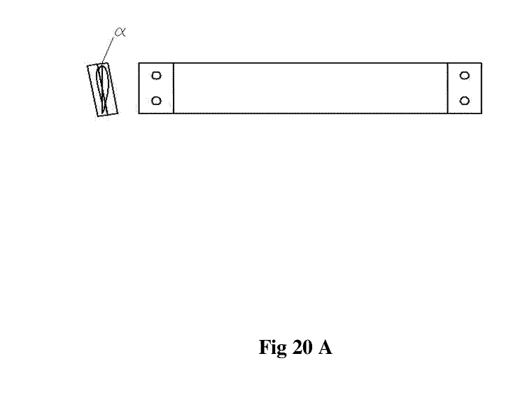

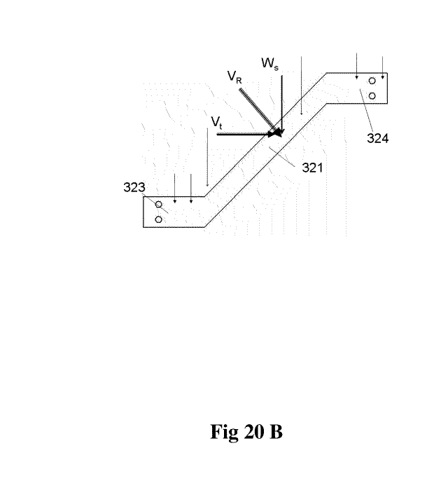

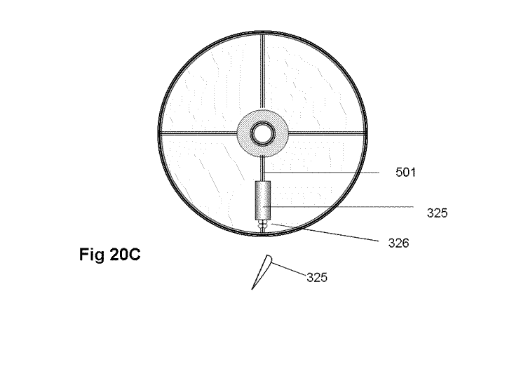

Unlike in the case of the cross flow model VAWT, the present symmetric flow model HAWT, is provided with non-symmetric airfoils set to a desired constant angle of incidence at all azimuth positions. FIGS. 19a, 19b, and 19c outline the method of computing blade angles for optimum performance. For a given tip speed ratio, k, the desired blade inclination, called the helix angle, ψ is determined such that the resultant velocity vector Vᵣ is nearly perpendicular to the blade leading edge, as shown in FIG. 20B, 321. For example,

Vₙ=Vᵣ*Cos(β)

Where β=π/2−φ−ψ, is the angle between Vᵣ and Vₙ, the normal velocity component, wherein, φ=arctan(1/λ), the angle between Vᵣ and Vₜ.

FIG. 20A shows a method of fabricating a non-symmetric blade profile, such that it will have constant angle of incidence α at all azimuth angle θ. Vertical milling machine will be used to cut the non-symmetric airfoil on a straight aluminum strip. This strip will be placed on a metallic drum of required curvature and contoured into a helix of required degree depending on number of blades used.

### Methods of Achieving Starting Torque in Axis Symmetric Flow Models

FIG. 20B shows a method of achieving the starting torque, wherein the first end and the last end of the helically contoured blade has some part of its leading edges, 323, 324, set normal to the onset streamline, so as to generate the starting torque.

Still another method of achieving the starting torque is presented in FIG. 20C, wherein, a small strip of non-symmetric blade is mounted on plurality of supporting arms, 501, 504. This arrangement resembles the tip section of the conventional radially extended blade of a HAWT turbine. The blade strip 325 is provided with a pitching device, similar to the present inventor's blade pitching device proposed in the U.S. Pat. No. 7,789,624 B2. Wherein, the blade strip is mounted on a supporting arm 501. At the far end of the radial arm, the blade strip is restrained against a spring 326. Initially, the blade strip is mounted at low angle of incidence with respect to the onset flow. As the rotor builds up rotational speed, the blade angle changes as defined by the cam groove, so as to provide optimal starting torque and also to control the rotor speed. Thus, there is no need for pitching the helically contoured blades.

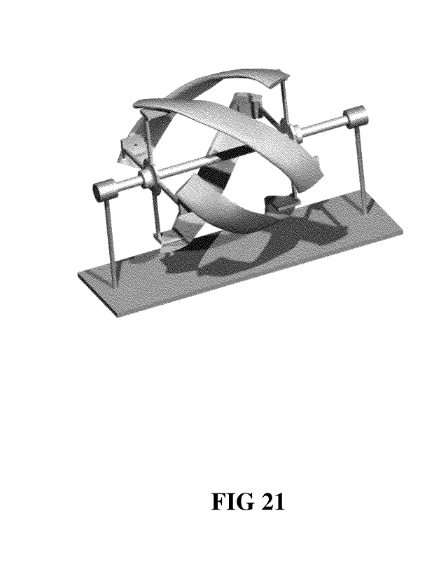

FIG. 21 shows a typical rotor assembly having helically contoured blades. A typical light weight blade assembly is depicted in FIG. 2.

Likewise, the inner aerodynamic rotor 503, in turn comprises of an assembly of plurality of similarly helically contoured light weight composite blades, mounted on plurality of supporting arms 504, which are in turn mounted on a rotating coaxial shaft 508, which in turn is coupled to the magnetic field unit 103 of said alternator 509. Due to axis symmetric flow and helical configuration of the blades mounted on inner and outer rotors, constant torque is generated at all azimuth locations of the rotor, without giving rise to any pulsating forces. Hence no blade pitching device is required for the blades mounted on inner and outer rotors. The assembled CR-HAWT 500A is then mounted on a stationary supporting frame work 500, and 511. To ensure unidirectional rotation of the outer and inner rotors, a set of unidirectional and load carrying bearing units 505 and 506 are employed.

To transfer the electrical power generated by the rotating armature, a slip ring assembly 510 is implemented. The dual rotor alternator unit 509 is supported by an assembly of cam rollers, 512, 513. The total CR-HAWT assembly will be supported on a bearing support unit 514, comprising a set of cam rollers and load carrying bearings. To ensure better dynamic stability, the support 514 is positioned near the centre of gravity of the total system. Further, to provide passive yawing, an appropriate axial length of the rotor will be selected based on the aerodynamic side force required to position the rotor with respect to the wind direction.

### CR-HAWT Disposed in Coaxially Ducted Flow Environment:

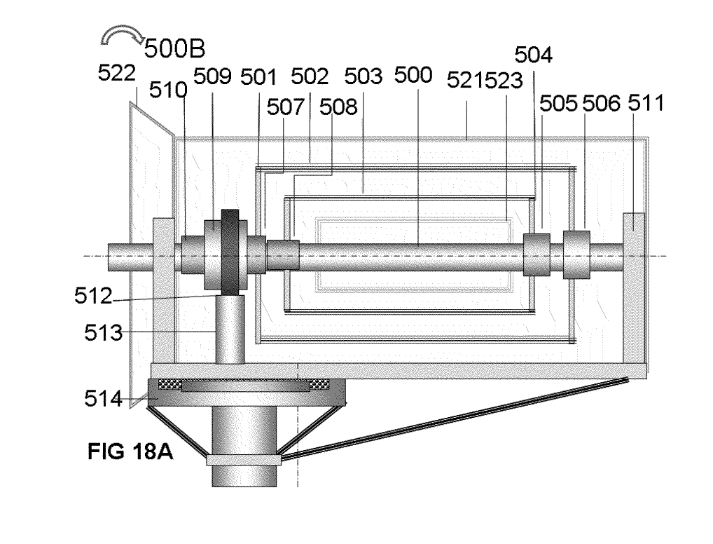

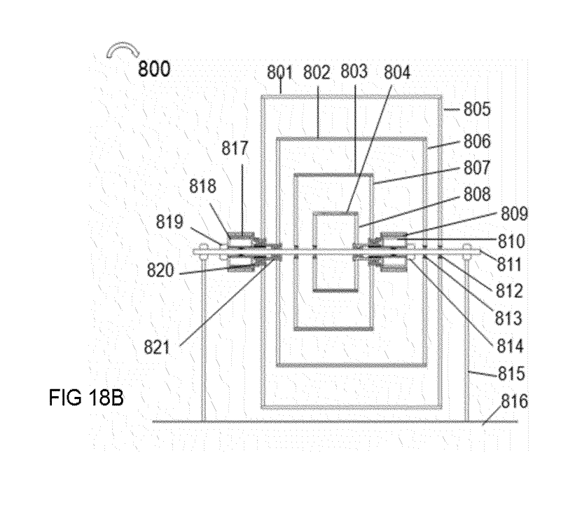

According to an embodiment, an alternate version of energy extraction improvement can be achieved by disposing a CR-HAWT 500B unit in a ducted flow environment as depicted in FIG. 18A. Wherein, FIG. 18A illustrates a sectional view of a contra rotor horizontal axis wind turbine 500B, having dual rotors set to spin in opposite direction to each other. The center section of the turbine within the inner rotor is enclosed by means of a stationary duct 523 having its first end and its second end sections enclosed by means of spherical domes, so that the fluid accelerates smoothly into the bladed rotor domain, thus leading to more efficient method of energy extraction. Said inner conduit 523 is supported on a stationary supporting element 500.

The uniform section of the outer duct 521 may be connected to a fluid conveying duct as in the case of water turbine penstocks, or a duct conveying hot gases as in the case of gas turbines or steam turbines, to generate energy.

However, if said turbine is used as wind turbine, said duct 521 may be interfaced with a conical inlet 522, so that a larger inlet area is used to collect more of fluid mass. Although, the mass flow is the same in both cases, it increases the fluid velocity, so as to provide additional power extraction.

The details of the components of the CR-HAWT unit are provided earlier, in FIG. 17, except for the inner and outer ducts.

### Plurality of Contra Rotor Units in Open Air:

In the case of axial flow turbines, which are provided with plurality of helically contoured blades, it is only possible to extract the kinetic energy from the fluid mass surrounding the blade surface. As such the remaining section of the stream tube can be engaged by other set of contra rotors. According to one embodiment, one version of the energy conversion efficiency improvement, is outlined in FIG. 18B, wherein plurality of contra rotor turbine units are assembled to form an integrated set of an energy efficient turbine unit 800.

In accordance with an embodiment, FIG. 18B depicts multiple pairs of contra rotor units, such as 801, 802 and 803 804, as described earlier, these rotors are coupled to two elements of an alternator; armature 817, and the magnetic field unit 818. Likewise, the CR pair 803, 804 is coupled to another set of alternator elements 809, 810. Similarly, additional units, in principle, can be assembled to extract additional energy from the same flow field. Several pairs of one-way bearings, 812, 813 are used to ensure each rotor pairs spin opposite to each other. The total assembly is supported on a stationary shaft 811 and other frame work 815, 816.

FIG. 21 shows a typical plot of the power performance of an outer rotor of an offshore utility scale wind turbine rated at 10 MW placed in an open environment. The geometric dimensions shown are seems to be significantly light weight and cost effective compared to the conventional radially extending bladed HAWT units.

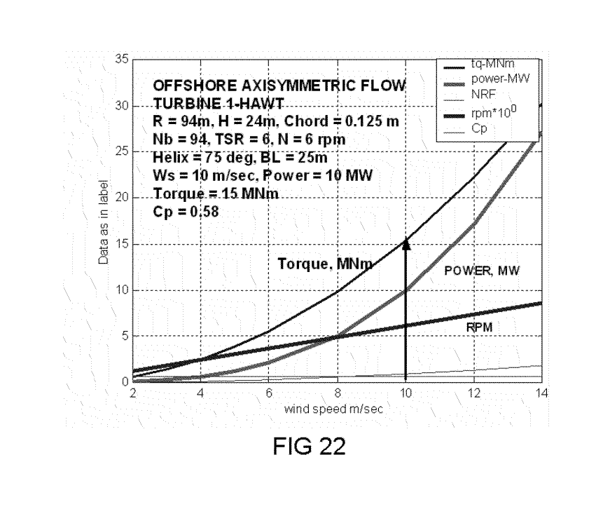

FIG. 22 shows the power performance characteristics of the same single rotor HAWT disposed in a coaxially ducted flow environment, wherein the radius of the inner duct 523 is half that of the outer duct 521. For the same mass flow through the same rotor diameter, the power output is seen to be significantly improved versus that in the open flow environment. The main reason being that the kinetic energy of the inner section flow mass was unaffected by the rotor in the first case. In the second case, the mass of fluid is redirected to flow around the rotor, and permitting to release additional energy. Thus, the Cp of this flow configuration could be as high as 0.75, similar to that of a water turbine.

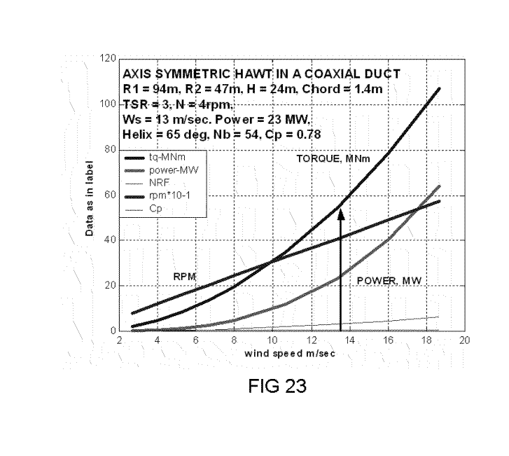

FIG. 23 shows the power performance characteristics of the same single rotor HAWT disposed in a coaxially ducted flow environment.

### Floating Platforms for Offshore Contra Rotor Wind Turbines:

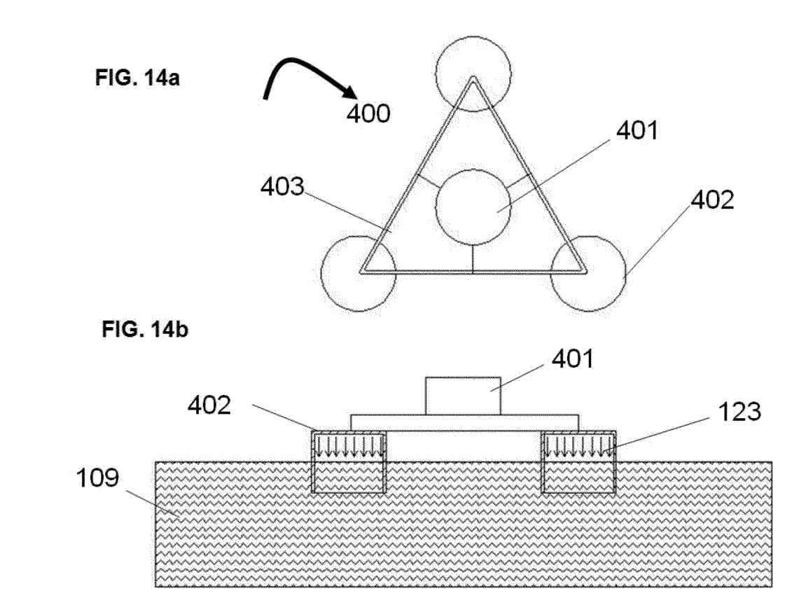

In the case of multi-megawatt utility scale deep sea based wind turbines, a special type of floating platforms are required to maintain stability in extreme wind conditions. For example, 10 to 20 MW units may have nearly 400 m rotor diameter and nearly 150 to 200 m rotor height, weighing around 100 to 200 tons. For stability, the base need be large. A typical suggested floating platform 400 is depicted in FIG. 14a as the plan form, and in FIG. 14b as its elevation. In which, the rotor assembly 401 is located at the center, connected by a network of framed structure comprising of cushioning units 402, and supporting tubular structure 403. The air cushioned units 402 may be pressured to balance the weight, whereas the dimension of the tubular elements 403 may be selected to ensure stability at all wind conditions at a given site.

### Land Based Version of the CR-VAWT

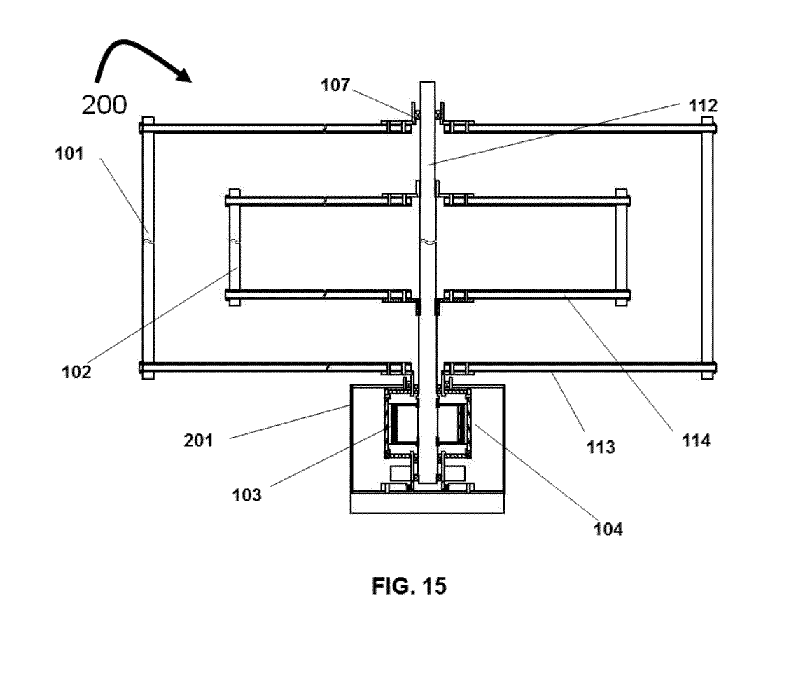

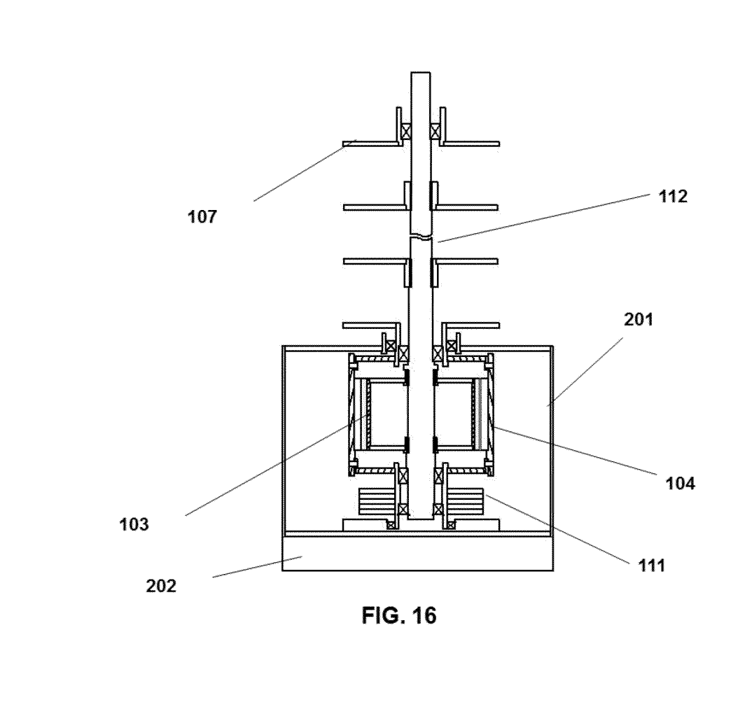

The land based version of the CR-VAWT unit 200 is depicted in FIG. 15. This is similar to the sea based unit except its mounting is on a land based tower. FIG. 16 describes the alternator assembly and its assembly on a tower based supporting unit 201.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A contra rotor turbine system for converting kinetic fluid energy of any liquid or gaseous media into electrical energy comprising:
a supporting frame work;
an electrical power generating alternator, driven by said contra rotor configured turbine system;
a pair of contra rotating helically contoured bladed rotors, having their axes of rotation set either in vertical direction in order to extract energy from a cross flow fluid media, or in a horizontal direction so as to extract energy from an axial flow fluid media, supported on said frame;
a pair of aerodynamic torque producing helically contoured bladed rotors include an inner rotor and an outer rotor, wherein each rotor having plurality of helically contoured blades supported by hinged or firmly fixed means to a frame work of each rotor;
wherein said outer rotor firmly supported on to an outer shaft having its blade pitch set to spin the first rotor in a first direction, wherein said inner rotor firmly fixed to a coaxially mounted inner shaft and its blade pitch set to spin the second rotor in a second direction, opposite to the first direction;
wherein said inner shaft coupled to the magnetic field element of an electrical generator and said outer shaft coupled to a wound armature of said generator, thereby said contra rotor vertical axis and/or horizontal axis wind turbines benefit aerodynamically and electrically, since the magnetic flux speed increases due to the contra rotation of the magnetic field and wound armature of said electrical generator, leading to substantially increased production of annual energy.

2. The system of claim 1 further comprises a coaxial slip ring assembly transmits power generated by said alternator; and
a protective rotor speed control by modifying flux strength to modulate torque;
wherein, a pair of unidirectional and load carrying bearing assembly units employed to ensure satisfactory performance of said rotors and the alternator.

3. The system of claim 1, wherein said alternator comprises of a magnetic field unit driven by one rotor, while a wound armature unit driven by another rotor in opposite direction to said one rotor, leading to increased electrical efficiency and reduced weight and reduced cost per unit of power generated.

4. The system of claim 1, wherein the light weight blade fabrication comprises of helically contoured and reinforced composite spar extending from the first end of the blade to the second end of the blade having terminal hinged fixtures permitting bending free extensional force.

5. The system of claim 1, wherein the contra rotor vertical axis wind turbine (CR-VAWT) is employed to extract energy from kinetic fluid flow in cross flow environment.

6. The system of claim 1, wherein the contra rotor horizontal axis wind turbine (CR-HAWT) is employed to extract energy from kinetic fluid flow in axial flow environment.

7. The system of claim 5, wherein said contra rotor vertical axis wind turbines comprising efficient means of energy conversion, simplicity in component design, leading to cost effective fabrication, assembly, and operation without requiring active control devices for blade pitching and yawing.

8. The system of claim 6, wherein said contra rotor horizontal axis wind turbines comprising efficient means of energy conversion, simplicity in component design, leading to cost effective fabrication, assembly, and operation without requiring active control devices for blade pitching and yawing.

9. The system of claim 7 or 8, wherein said contra rotor vertical and/or horizontal axis wind turbines comprising of a multiple units of air-cushioned floating platform leading to reduced cost of installation and maintenance in deep sea waters, without requiring the tubular tower installation.

10. The system of claim 6, wherein the horizontally positioned contra rotor wind turbine system disposed in co-axial conduits leads to increased energy extraction.

11. The system of claim 6, wherein the axially positioned contra rotor wind turbine system is designed in turbines including water turbines, gas turbines, stream turbines or offshore wind turbines.

12. The system of claim 3, wherein increased electrical efficiency, reduced alternator weight and reduced alternator cost resulting from higher flux speed due to contra rotation of two rotors.

13. The system of claim 1, wherein load generating aerodynamic blades are light weight with reduced mass inertia, leads to early start at low wind speeds, leading to increased annual energy production.

14. The system of claim 3, wherein the self balanced torque loads makes the support simpler, especially in offshore installation.

15. The system of claim 1 applies to land based, offshore based wind turbine installations, rooftop based installation, and ships.

16. The system of claim 1, wherein the contra rotation of said blades extract kinetic energy from wind, while moving against the wind in each case.

17. The system of claim 10, wherein said duct may have conical shaped inlets to increase mass flow and extract more energy from a small turbine unit.

18. The system of claim 10, wherein the contra rotor system is disposed in a fluid media contained between two coaxial conduits, extracts more energy from the fluid media, than in the case of a single conduit.
